(19) United States
(12) Patent Application Publication
(10) Pub. No.: US 2016/0094705 A1
(43) Pub. Date: Mar. 31, 2016

(54) Message Read Confirmation Using Eye Tracking

(71) Applicant: RingCentral, Inc., San Mateo, CA (US)

(72) Inventor: Vlad Vendrow, Redwood City, CA (US)

(21) Appl. No.: 14/501,804

(22) Filed: Sep. 30, 2014

(51) Int. Cl. H04M 1/725; H04W 4/12; H04L 12/58; G06K 9/00; G06F 3/01

(52) U.S. Cl. CPC H04M 1/72547; G06K 9/0061; G06F 3/013; H04L 51/34; H04W 4/12

(57) ABSTRACT

An electronic device generates a message read confirmation by using eye tracking. The device tracks a position of a user's eye while the user is viewing a displayed electronic message. The device generates a plurality of features associated with the user's viewing of the electronic message based on the tracked position of the eye. The generated features include, for example, a number of lines of the displayed electronic message viewed by the user. The device then generates a message read confirmation after determining that the user has read the displayed electronic message based on the generated plurality of features. The tracking of the eye position can be implemented by capturing images representing the eye position. Based on analyzing a series of the captured images, the device can also determine that the eye has stayed within a threshold distance and, responsively, enhance (e.g., zoom) the displayed electronic message.

### BACKGROUND

This disclosure generally relates to electronic messaging systems, and specifically to optimize viewing of electronic messages on electronic messaging systems using eye tracking.

Electronic messaging systems include functions for receiving and displaying electronic messages to users. Electronic messages can include one-to-one communications such as instant messaging, text messaging, electronic mail (“email”), voicemail, fax message, and paging, or one-to many communications such as an Internet forum and a bulletin board system. An electronic messaging system displays electronic messages such that a user can view or read the displayed messages. The content of electronic messages can be text-based, image-based, or video-based.

### BRIEF DESCRIPTION OF THE DRAWINGS

FIG. 1 is a block diagram of a system implementing message read confirmation using eye tracking, according to an example embodiment of the present disclosure.

FIG. 2 is a block diagram illustrating an implementation of a message read confirmation using eye tracking, according to an example embodiment.

FIG. 3 is a block diagram illustrating eye tracking for message read confirmation, according to an example embodiment.

FIG. 4 is a flowchart illustrating a method of generating message read confirmation using eye tracking, according to an example embodiment.

FIG. 5 is a block diagram illustrating an implementation of a display resolution enhancement using eye tracking, according to an example embodiment.

FIG. 6 is a block diagram illustrating eye tracking for display resolution enhancement, according to an example embodiment.

FIG. 7 is a flowchart illustrating a method for display resolution enhancement using eye tracking, according to an example embodiment.

FIG. 8 is a block diagram illustrating an electronic device that implements message read confirmation and display resolution enhancement using eye tracking, according to an example embodiment.

The figures depict various example embodiments of the present disclosure for purposes of illustration only. One skilled in the art will readily recognize from the following discussion that other example embodiments based on alternative structures and methods may be implemented without departing from the principles of the disclosure.

### DETAILED DESCRIPTION

A common functionality in electronic messaging is the read receipt, in which a sender of an electronic message (e.g., an email) receives a notification when a recipient of the email reads the email. When the recipient opens the email message to read it, the system marks the email as “read” and generates a notification to the sender that the email message has been read by the recipient. However, the recipient might have opened the email message merely to identify the subject matter of the email message and decided to read the email message later. Conventional electronic messaging systems still mark the email message as “read” the first time that the email message is opened, viewed, or selected for viewing by the recipient, regardless of whether the recipient has actually read the email message in its entirety.

An electronic device generates a message read confirmation by using eye tracking. The device can capture a series of images representing an eye of a user while the user is viewing a displayed electronic message. The device can detect a position of the eye for each of the captured images and generate a plurality of features associated with the user's viewing of the electronic message based on the detected position. For example, the features can include a number of lines of the displayed electronic message viewed by the user. The device can generate an electronic message read confirmation by determining whether the user read the displayed electronic message based on the generated plurality of features.

The device can also use the captured images of the eye position to enhance a localized resolution of a displayed electronic content. The device can determine a first portion of the displayed electronic content, where the detected position of the eye has stayed within a distance of a reference position for a consecutive series of the captured images. A localized display resolution of the first portion can be enhanced up to a native resolution of a display displaying the electronic content. The device can determine a second portion of the displayed electronic content for reducing a localized display resolution to reduce power consumption, where the second portion is different from the first portion.

A few example advantages of message read confirmation include generating a notification that an electronic message was viewed, determining whether an electronic message was viewed in its entirety or only partially, determining importance of an electronic message based on a number of times the electronic message is being viewed, determining emotional reactions of user while viewing electronic messages, and modify a localized resolution of displayed electronic content of an electronic message.

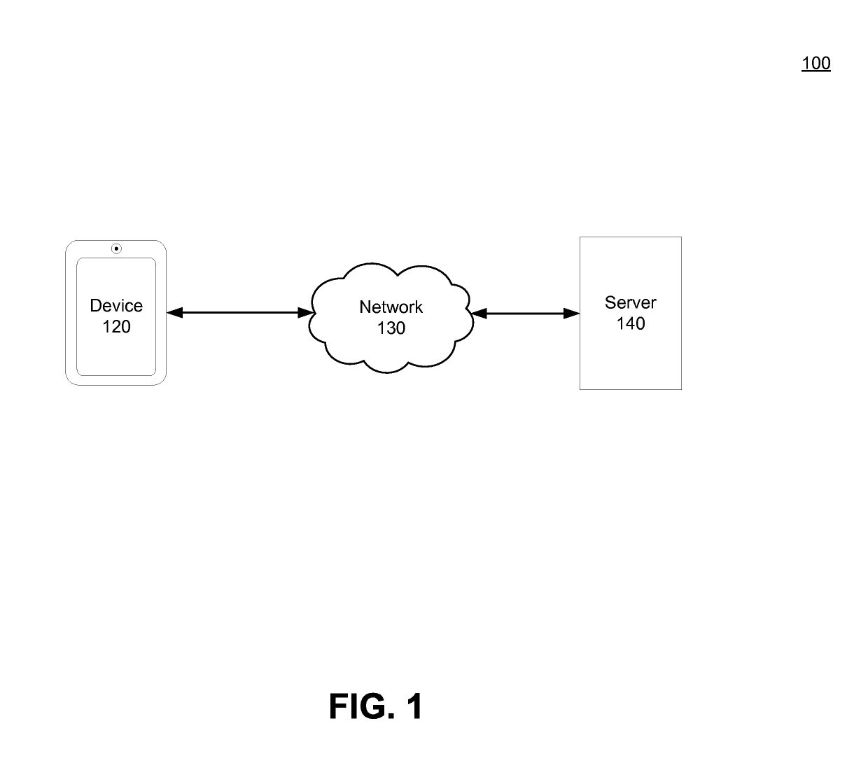

Referring now to FIG. 1, there is shown a high-level block diagram of a system implementing message read confirmation using eye tracking, according to an example embodiment of the present disclosure. The system shown in FIG. 1 includes device 120 that displays an electronic message to be viewed by a user. FIG. 1 also shows server 140 and network 130 that server 140 uses to interact with device 120.

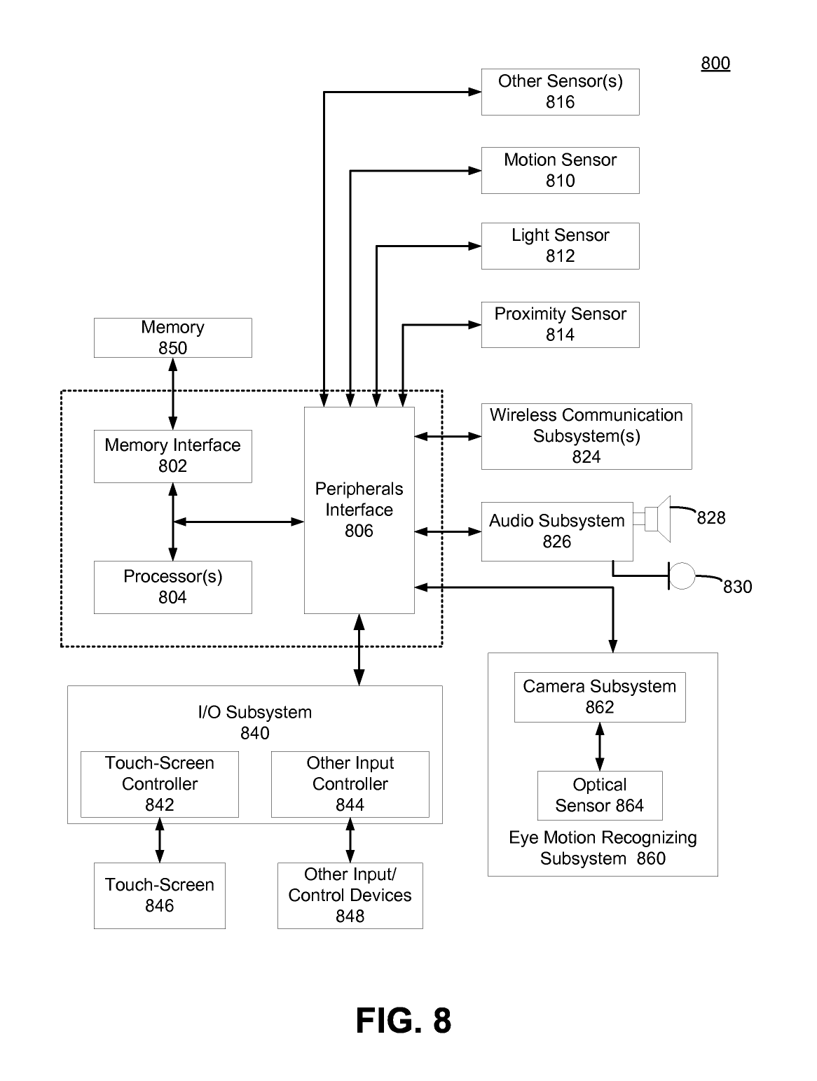

Device 120 is an electronic device such as cell phone, smart phone, desktop phone with a display, audio and/or video conferencing device, tablet, computer, and gaming console that can implement message read confirmation using eye tracking. Device 120 includes, among other components, a camera and a display. The camera is used to capture images of a user's eye while the user is viewing or reading an electronic message. In alternate embodiments, the device 120 tracks the user's eye by measuring the movement of an object such as a special contact lens attached to the eye, by optical tracking without direct contact to the eye, by measuring electric potentials using electrodes placed around the eyes, or other know eye tracking methodologies. The display of device 120 is used to display the electronic message being viewed or read by the user. Device 120 is described below in detail with reference to FIG. 8.

Network 130 allows device 120 to interact with server 140. In an example embodiment, network 120 uses standard communications technologies and/or protocols. Thus, network 120 can include links using technologies such as Ethernet, 802.11 standards, worldwide interoperability for microwave access (WiMAX), WiFi, 3G, digital subscriber line (DSL), etc. The data exchanged over network 120 can be represented using technologies and/or formats including the hypertext markup language (HTML), the extensible markup language (XML), etc.

Server 140 is coupled to device 120 via network 130 for managing electronic messages. Server 140 operates in a client-server architecture, where server 140 serves client devices such as device 120 based on any requests received from the client devices. Some of the functions that server 140 can perform include hosting, storing, and providing electronic messages. In some example embodiments, server 140 can provide virtual private branch exchange (vPBX) services including telephony, fax, and electronic messages.

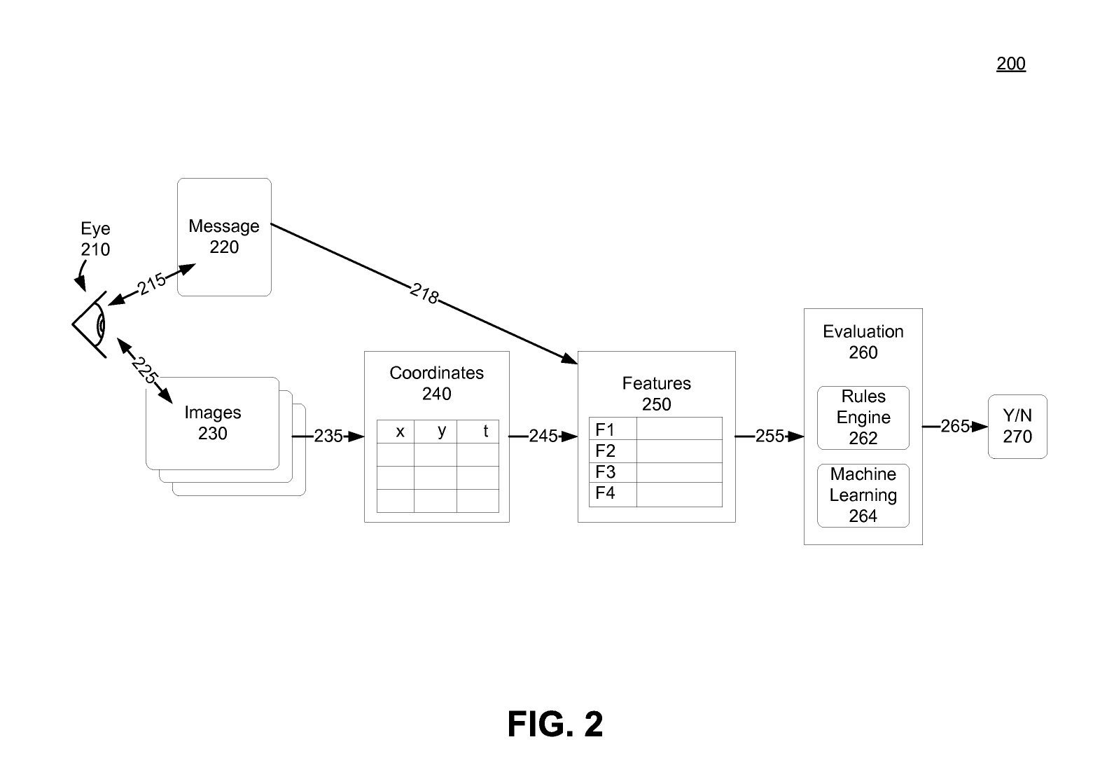

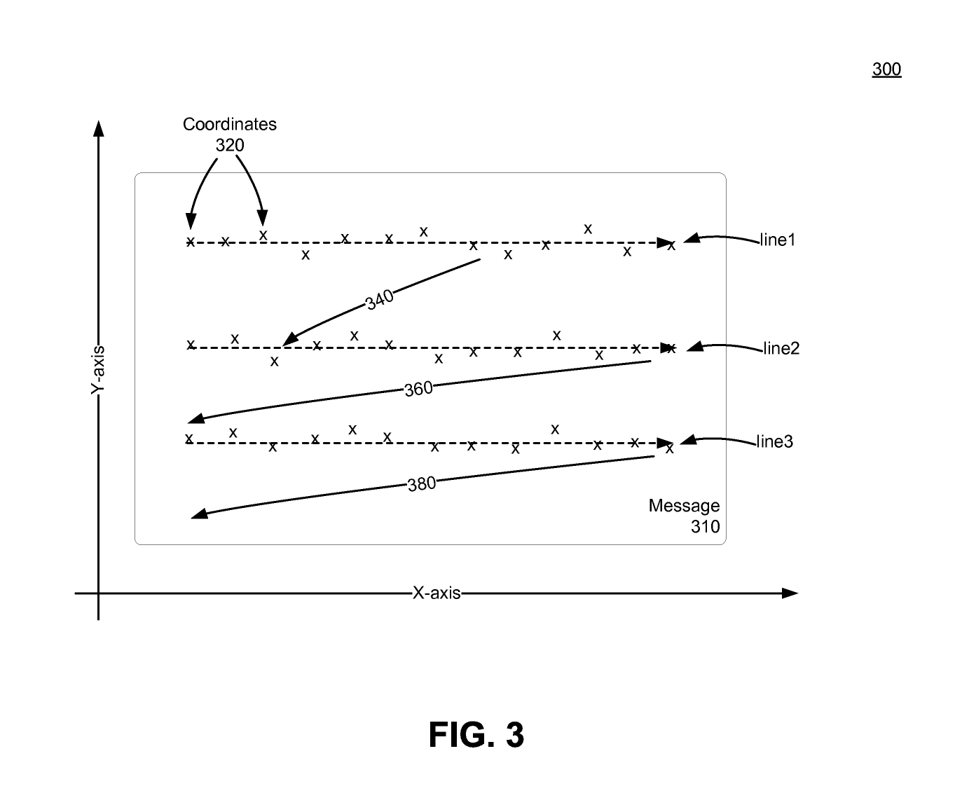

In an example embodiment, a subset of the tasks involved in an implementation of message read confirmation using eye tracking are implemented at server 140. In such example scenario, device 120 requests server 140 to implement a subset of the tasks involved in an implementation of message read confirmation. Alternatively, a complete implementation of message read confirmation can be implemented at the client device (i.e., device 120) itself. An implementation of message read confirmation using eye tracking is described in detail below with reference to FIGS. 2 and 3.

FIG. 2 is a block diagram illustrating an implementation of a message read confirmation using eye tracking, according to an example embodiment. FIG. 2 includes various tasks involved in the implementation of message read confirmation using eye tracking.

The implementation of message read confirmation includes displaying an electronic message 220 on a device (e.g., device 120 shown in FIG. 2). In response to displaying electronic message 220, the device extracts 218 a first set of features associated with the displayed electronic message 220. The device tracks the user's eye (as shown in FIG. 2 by element 210) position while the user is viewing the displayed electronic message 220. The device extracts a second set of features associated with the tracking of user's eye position (either one or both eyes of the user) while the user is viewing the displayed electronic message 220. The device then determines whether the user has completed viewing of the displayed electronic message 220 based on the extracted first set of features and the second set of features, as described in detail below.

FIG. 2 shows the user's viewing 215 of the displayed electronic message 220. The user can select an electronic message to be displayed and the device displays the selected message in response to receiving the user's selection. For example, the device receives a user selection of an electronic message 220 to be displayed by receiving clicking of a mouse button associated with the device or by receiving a gesture on a touch screen of the device selecting the electronic message. Arrow 215 represents the user's viewing or reading of the displayed electronic message 220.

In addition to displaying electronic message 220, a processor (e.g., processor 804 shown in FIG. 8) of the device can perform some processing actions on electronic message 220 to extract 218 a first set of features associated with electronic message 220. The extracted first set of features of electronic message 220 can include, for example, a number of lines of electronic message 220 displayed on the device, an average number of characters included in a line of electronic message 220, an average amount of time a user is expected to take to read a line of electronic message 220, and an amount of time a user is expected to take to read the entire electronic message 220. The extracted first set of features can also include a determination whether the displayed message includes an image and how the image is displayed. For example, the first set of features can include a percentage of display area the image occupies and also a location of the image relative to the dimensions of the display.

An eye motion subsystem (e.g., eye motion subsystem 860) of the device can track the user's eye position while the user is viewing the displayed message 220. One way to track eye movements is by using an optical tracking of the eye without direct contact to the eye. Other methods include eye-attached tracking, where the eye movements are measured by the movement of an object that is attached to the eye, and electric potential measurement tracking, where the eye movements are measured by measuring electric potentials using electrodes placed around the eyes. An example optical tracking method includes video-based eye tracker that typically uses the corneal reflection and the center of the pupil as features to track while the user is viewing the message. In an example embodiment, the eye motion subsystem tracks eye movements of both eyes of the user. Alternatively, the eye motion subsystem tracks only one eye of the user.

The device captures 225 a video or a plurality of images 230 while the user is viewing the displayed electronic message 220. As the user continues viewing the displayed electronic message, a position of eye 210 continues to change. Computing a relative change in a position of eye 210 (e.g., center of eye 210) can provide an indication of which portion of the displayed electronic message 220 the user is viewing. One method of capturing a relative position of eye 210 is to capture a plurality of images 230 (or a video) of eye 210 with respect to time. Images can be captured at a rate that is fast enough to ensure that the device captures all relevant changes in a relative position of eye 210 while the user is viewing electronic message 220. For example, a capture rate of 5 images per second can be sufficient.

The plurality of images 230 are converted 235 into a plurality of coordinates 240. Each coordinate of the plurality of coordinates 240 corresponds to each image of the plurality of images 230, where each image represents a position of eye 210 when eye 210 is viewing a particular location of electronic message 220. For example, each coordinate represents a position of eye 210 translated into a Cartesian coordinate comprising values for X-axis and Y-axis. For a given coordinate, a value along the X-axis represents a location information of an area that eye 210 is viewing along a horizontal direction of the display and a value along the Y-axis represents a location information of the area that eye 210 is viewing along a vertical direction of the display. An example embodiment for representing coordinates in a Cartesian space is described in detail below with reference to FIG. 3. In an example embodiment, each coordinate also includes information of time at which the image associated with the coordinate is captured. In an example embodiment, the device tracks the eye movement continuously and generates the plurality of coordinates 240 without having to first capture the plurality of images 230. The device can complement the eye tracking with user selections such as scrolling down and pointing a cursor to improve the accuracy of the eye tracking results.

The plurality of coordinates 240 are mapped 245 into a second set of features associated with tracking of the eye movements while the user is viewing the displayed electronic message 220. The extracted second set of features of electronic message 220 can include, for example, a number of lines of displayed electronic message 220 viewed by eye 210, an amount of time spent by eye 220 viewing electronic message 220, a cumulative change in the position of eye 210 along a horizontal direction, and a cumulative change in the position of eye 210 along a vertical direction. The second set of features can also be associated with tracking viewing of images when the displayed electronic message includes images, determining an importance of text of the displayed electronic message based on a number of times the user views the electronic message, calibrating the system based on a user reading the displayed electronic message and confirming an estimated number of lines to improve accuracy, accounting for differences in the user's gaze to improve accuracy and avoid measurement errors, and compensating for errors in eye movement detection.

One method of determining a number of lines viewed by the user is by detecting an end of a line based on comparing the differences of X-coordinates and that of Y-coordinates. For example, when a magnitude of a difference of a value along the X-axis between successive coordinates is much larger compared to a magnitude of a difference of a value along the Y-axis between the successive coordinates, an end of the line can be detected. One method of determining an amount of time spent by the eye while viewing the electronic message is based on a number of captured images while the user is viewing the electronic message. For example, an amount of time can be determined by a number of images captured at a given rate of image capture (e.g., 5 images per second).

Evaluation module 260 determines 265 whether electronic message 220 was read or viewed completely by the user based on receives the extracted plurality of features 250. For example, determination 265 results in a Yes (as depicted by Y/N block 270) corresponding to electronic message 220 being read (or viewed) completely or a No (as depicted by Y/N block 270) corresponding to electronic message 220 not being read (or viewed) completely. In some example embodiments, the determination 265 is implemented by using either rules engine 262 or machine learning 264.

Rule engine 262 comprises one or more rules for determining whether the user read electronic message 220 or not. Instructions associated with rules of rules engine 262 are hardcoded before electronic message 220 is displayed. An example list of rules includes the following: whether a number of lines of electronic message 220 viewed by eye 210 is greater than a percentage (e.g., 60%) of a number of lines of the displayed electronic message 220, whether an amount of time eye 220 viewed the displayed electronic message 220 is greater than a percentage (e.g., 50%) of an amount of time expected for the displayed electronic message 220 to be read, whether a cumulative change in position of the eye in a horizontal direction is within a range of expected change (e.g., between 60 and 80% of a visible dimension in the horizontal direction of the display area) in the horizontal direction, and whether a cumulative change in position of the eye in a vertical direction (e.g., between 50 and 70% of a visible dimension in the horizontal direction of the display area) is within a range of expected change in the vertical direction.

In an example embodiment, evaluation module 260 determines whether the user has read the electronic message by determining whether the number of lines viewed by the eye is greater than a percentage of a number of lines of the displayed electronic message. Evaluation module 260 also determines a number of times the user has read the electronic message based on the number of lines viewed by the eye and the number of lines of the displayed electronic message. For example, a ratio of the number of lines viewed by the eye and the number of lines of the displayed electronic message will result in the number of times the user has read the electronic message. The electronic message can be categorized based on the number of times the user has read the electronic message. For example, if the number of times the user has read the electronic message exceeds a particular number, the electronic message is categorized as important and the electronic message is be marked as such in the user's inbox.

Evaluation module 260 determines the user's emotional reaction by the eye tracking. In an example embodiment, evaluation module 260 determines whether the user was surprised while viewing the electronic message by a comparison between the amount of time spent by the eye while viewing the electronic message and an amount of time expected for the displayed electronic message to be read. For example, if the amount of time spent by the eye while viewing the electronic message is half of the amount of time expected for the displayed electronic message to be read, a determination is made that the user was surprised. Evaluation module can also determine if the user is distracted while viewing or reading an electronic message. For example, if the user is gazing away from the displayed text of the electronic message at a particular frequency, a determination is made that the user is distracted.

Alternatively, evaluation module 260 can determine whether electronic message 220 was read by using machine learning model. Machine learning deals with a study of systems that can learn from data they are operating on, rather than follow only explicitly programmed instructions like in rules engine 262. Machine learning for evaluating whether a user has read electronic message 220 can be implementing using a machine learning module 264. Machine learning module 264 can use supervised learning, where the module is presented with a data set of example inputs and their desired outputs such that machine learning module 264 can develop a general rule that can map any input to an output. For example, machine learning module 264 can be presented with example inputs associated with extracted plurality of features 250 and their corresponding desired outputs (i.e., whether electronic message is read or not) such that module 264 can develop a general rule that outputs a likelihood of electronic message 220 being read for any arbitrary inputs.

FIG. 3 is a block diagram illustrating eye tracking for message read confirmation, according to an example embodiment. FIG. 3 shows a position of an eye's focus during a process of an eye tracking to determine whether an electronic message (e.g., message 310) is read or viewed completely by a user. The position of the eye's focus (or focal point) relative to lines of the displayed electronic message on the display is shown in FIG. 3 in a Cartesian space with X-axis representing the position of the eye in a horizontal direction and Y-axis representing the position of the eye in a vertical direction. FIG. 3 shows electronic message 310 displayed on a device (e.g., device 120). Electronic message 310 comprises a plurality of lines that are displayed on the device and are to be read by the user. FIG. 3 shows three exemplary lines, line1, line2, and line3, of the plurality of lines. Along each line, a plurality of coordinates 320 corresponding to a plurality of images (e.g., images 230) captured while the user is viewing electronic message 310.

Each coordinate of the plurality of coordinates 320 represents a viewing of the eye at a particular area (e.g., a particular word of a particular line) of the displayed electronic message 310. The viewing of the particular area is translated into an X-Y Cartesian coordinate of the particular area of the displayed electronic message. The process of translation of each image into a coordinate is repeated for all images of the plurality of images 230 to generate the plurality of coordinates 320. Each coordinate of the plurality of coordinates 320 are generated by calculating a change in the position of the eye between the image that corresponds to the coordinate being generated and an image that is immediately prior to the image. In this example implementation, each coordinate is generated based on a relative change in position of the eye between successive images of the plurality of images 230. In an example embodiment, the system ignores coordinates that are determined to be outliers. For example, while viewing line1 of the displayed electronic message, if a subsequent coordinate represents a coordinates that corresponds to line3, the system can identify the subsequent coordinate as an outlier based on relative values of X and Y coordinates, and disregard the subsequent coordinate.

While almost all of the coordinates of the plurality of coordinates 320 can be generated using relative change in eye position over successive images, the very first coordinate requires an actual position of the eye when the eye is viewing the displayed electronic message for the first time. The actual position of the eye when the eye is viewing the displayed electronic message for the first time can be estimated based on empirical data of how users view a displayed electronic message. For example, a set of empirical data is generated by observing a representative sample of users while the users view a displayed electronic message. The empirical data can include a distance between the user's eye and displayed electronic message, and also include an angle at which the user views the displayed electronic message. Based on the empirical data, the first coordinate representing a position of the eye viewing a first area of displayed electronic message is estimated. After estimating the first coordinate, the other coordinates of the plurality of coordinates 320 can be generated using relative changes of the position of the eye.

FIG. 3 shows coordinates corresponding to a user's viewing of three lines, line1, line2, and line3, where the user is viewing of the electronic message from top left corner of the electronic message, views each line from left to right, and views the lines from top to bottom. That is, the user views line1 from left to right, then line2 from left to right, then line3 from left to right, and so on until the last line of the displayed electronic message. Tracking the X- and Y-coordinates corresponding to the user's viewing can generate interesting features. An example feature is to determine which part of a line the user was reading (or viewing) before the user transitions to reading (or viewing) to a second line. One method of determining a transition to a second line (i.e., transition 340 between line1 and line2) is based on comparing the differences of X-coordinates and that of Y-coordinates. For example, when a magnitude of a difference of a value along the X-axis between successive coordinates is much larger compared to a magnitude of a difference of a value along the Y-axis between the successive coordinates, a determination is made that a line transition occurred. While FIG. 3 shows the user viewing the electronic message from left to right and top to bottom, it is understood that the disclosure also supports electronic messages where the user might view the message from right to left and/or bottom to top.

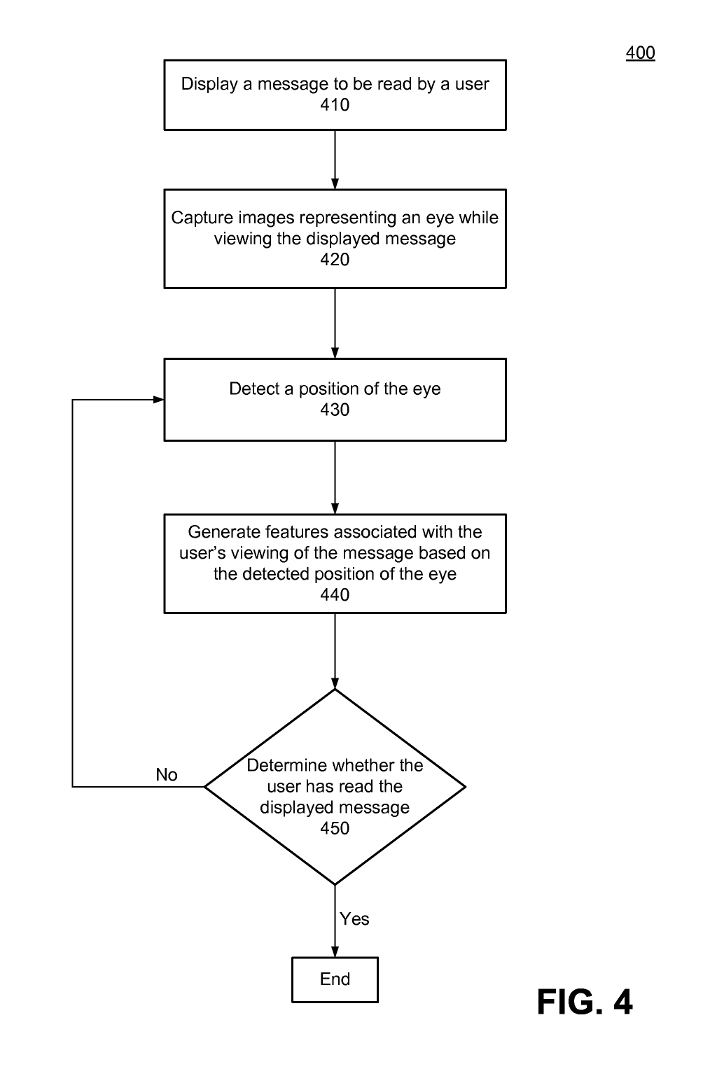

FIG. 4 is a flowchart illustrating a method of generating message read confirmation using eye tracking, according to an example embodiment. An electronic device (e.g., device 120 shown in FIG. 2) receives a selection of an electronic message to be displayed on a display of the device. The device then displays 410 the electronic message to be read or viewed by a user. The displayed electronic message can be an electronic message that is internally stored or generated within the device, or can be received external to the device. The displayed electronic message is either a text-based message or an image-based message.

An eye motion recognizing subsystem (e.g., eye motion recognizing subsystem 860) of the device subsequently detects the movement of user's eye(s) when viewing the displayed electronic message. In the presently described embodiment, the device captures 420 a plurality of images, where each image of the plurality of images represents an eye of the user while the user is viewing the displayed electronic message. For example, each image of the plurality of images represents a position of the eye while the eye is viewing a particular area (e.g., a particular word of a text-based message) of the displayed electronic message. The plurality of images can be captured at a rate that is fast enough to ensure that the device captures all relevant changes in a position of the eye.

The device detects 430 a position of the eye based on the captured images such that the device detects a position of the eye for each captured image. For example, the detected position of the eye corresponds to a center of the eye while the eye is viewing a particular area of the displayed electronic message. Alternatively, the detected position corresponds to the area of the displayed electronic message that the eye is viewing and the area is determined by extrapolating the eye position relative to the displayed electronic message. In an example embodiment, the detected position is represented as a Cartesian coordinate comprising a value along the X-axis for a location information of an area that the eye is viewing along a horizontal direction and a value along the Y-axis for a location information of the area along a vertical direction. Exemplary coordinates 320 are shown in FIG. 3.

In an example embodiment, each image of the plurality of captured images is converted into each coordinate of the plurality of coordinates such that each coordinate represents the detected position of the eye. Each image can be converted into each coordinate by extracting a change in the position of the eye between the image and an image of the plurality of images immediately prior to the image. That is, each coordinate is generated by computing a relative change in the position of the eye corresponding to consecutive images of the plurality of images.

A processor (e.g., processor 804) of the device generates 440 a plurality of features associated with the user's viewing of the electronic message, where the plurality of features include one or more features based on the detected position of the eye in the plurality of images. For example, the plurality of features associated with the user's viewing include a number of lines of the displayed electronic message viewed by the eye, an amount of time spent by the eye while viewing the displayed electronic message, a cumulative change in a position of the eye along a horizontal direction, and a cumulative change in a position of the eye along a vertical direction.

The device can determine a number of lines of the displayed electronic message viewed by detecting an end of a line based on comparing the differences of X-coordinates and that of Y-coordinates. For example, when a magnitude of a difference of a value along the X-axis between successive coordinates is much larger compared to a magnitude of a difference of a value along the Y-axis between the successive coordinates, an end of the line can be detected. The device can determine an amount of time spent by the eye while viewing the electronic message is based on a number of captured images while the user is viewing the electronic message. For example, an amount of time can be determined by a number of images captured at a given rate of image capture (e.g., 5 images per second).

In an example embodiment, the plurality of generated features also includes characteristics of the displayed electronic message. For example, characteristics of the displayed electronic message can include a number of lines of electronic message displayed on the device, an average number of characters included in a line of the displayed electronic message, an average amount of time a user is expected to take to read a line of the displayed electronic message, and an amount of time a user is expected to take to read the entire displayed electronic message. Alternatively, the plurality of features is generated, as described above, based on the generated plurality of coordinates that are associated with the user's viewing of the electronic message.

The processor of the device determines 450 whether the user has read the displayed electronic message based on the generated plurality of features. If the device determines 450 that the user read the electronic message, the method ends. On the other hand, if the device determines 450 that the user did not read the electronic message, the method reverts back to detecting 430 a position of the eye and repeats the method until the determination 450 returns that the user has read the displayed electronic message.

In an example embodiment, the device determines 450 whether the user read the displayed electronic message using a rules engine. The rules engine can include one or more rules exemplary rules as follows: whether a number of lines of the electronic message viewed by the eye is greater than a percentage (e.g., 60%) of a number of lines of the displayed electronic message, whether an amount of time the eye viewed the displayed electronic message is greater than a percentage (e.g., 75%) of an amount of time expected for the displayed electronic message to be read, whether a cumulative change in a position of the eye in a horizontal direction is within a range (e.g., between 40 and 60% of a visible dimension in the horizontal direction of the display area) of an expected change in the horizontal direction, and whether a cumulative change in a position of the eye in a vertical direction is within a range (e.g., between 30 and 50% of a visible dimension in the horizontal direction of the display area) of an expected change in the vertical direction.

Alternatively, the device determines whether the user read the displayed electronic message using machine learning model that receives the plurality of generated features and outputs a likelihood that the user has read the displayed electronic message.

In an example embodiment, the device determines whether the user has read the electronic message by determining whether the number of lines viewed by the eye is greater than a percentage of a number of lines of the displayed electronic message. The device can also determine a number of times the user has read the electronic message based on the number of lines viewed by the eye and the number of lines of the displayed electronic message. For example, a ratio of the number of lines viewed by the eye and the number of lines of the displayed electronic message will result in the number of times the user has read the electronic message. The electronic message can be categorized based on the number of times the user has read the electronic message. For example, if the number of times the user has read the electronic message exceeds a particular number, the electronic message can be categorized as important and the electronic message can be marked as such in the user's inbox.

In some example embodiments, the processor along with the eye motion recognizing subsystem of the device can also determine the user's emotional reaction by the eye tracking. In an example embodiment, the device determines whether the user was surprised while viewing the electronic message by a comparison between the amount of time spent by the eye while viewing the electronic message and an amount of time expected for the displayed electronic message to be read. For example, if the amount of time spent by the eye while viewing the electronic message is half of the amount of time expected for the displayed electronic message to be read, a determination is made that the user was surprised.

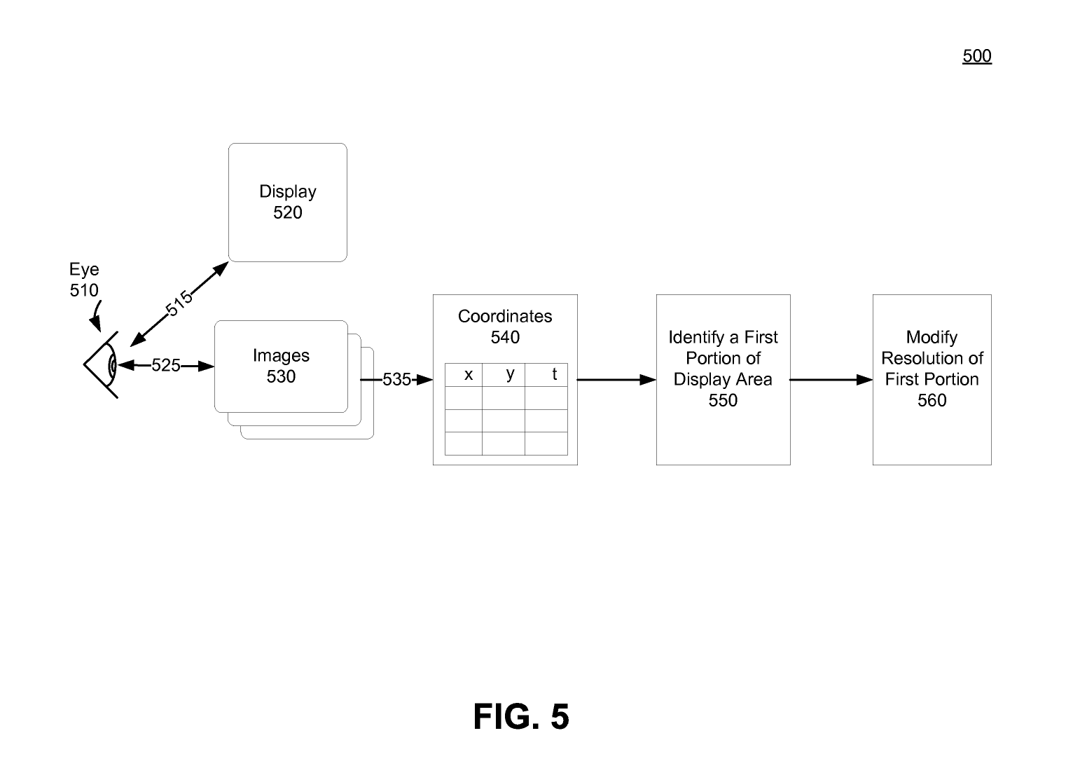

FIG. 5 is a block diagram illustrating an implementation of a display resolution enhancement using eye tracking, according to an example embodiment. FIG. 5 includes various tasks involved in the implementation of display resolution enhancement using eye tracking. The various tasks shown in FIG. 5 can be implemented entirely at a client device (e.g., device 120) or distributed between the client device and a server device (e.g., server 140).

The implementation of display resolution enhancement includes displaying electronic content 520 on a device (e.g., device 120). FIG. 5 shows a user's viewing 515 of displayed electronic content 520. The device tracks the user's eye position (either one or both eyes of the user) while the user is viewing the displayed electronic content 520. FIG. 5 also shows that the device captures 525 user's viewing of the displayed electronic content through a plurality of images 530. The plurality of images 530 are mapped 535 into a plurality of coordinates 540. A first portion of the displayed electronic content is identified 550, and a resolution of the identified first portion is enhanced 560.

Description associated with the tasks of user's viewing 515, capturing 525 of images 530, and mapping 535 the captured images into coordinates 540 are similar to that of the tasks of user's viewing 215, capturing 225 of images 230, and mapping 235 the captured images into coordinates 240 described above with reference to FIG. 2 with one difference. FIG. 2 illustrates user's viewing 215, capturing 225, and mapping 235 for an electronic message that is either text-based or image-based. On the other hand, FIG. 5 illustrates user's viewing 515, capturing 525, and mapping 535 for that is text-based, image-based, and/or video-based. The other tasks of identifying 550 a first portion of the displayed electronic content and modifying a localized display resolution of the identified first portion are described below in detail.

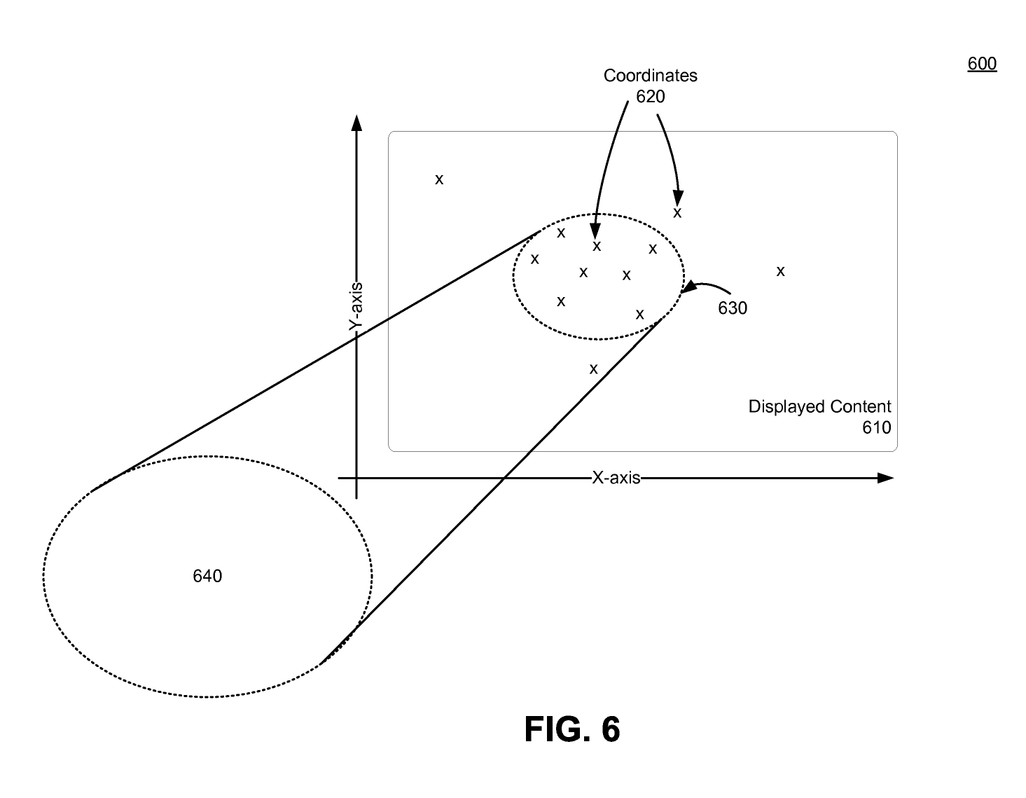

The eye motion recognizing subsystem of the device identifies 550 a first portion of the displayed electronic content that the user is gazing upon based on the plurality of coordinates 540. In an example embodiment, the first portion is identified by determining that the detected position of the eye for a consecutive series of the captured images has stayed within a distance of a reference position for a period of time. A value of the distance from a reference position can either be predetermined (e.g., hard-coded) or can be determined dynamically (e.g., programmed via software). Identifying a portion of the displayed electronic content is further described below with reference to FIG. 6.

The eye motion recognizing subsystem of the device then modifies 560 a localized display resolution of the identified first portion. In an example embodiment, the localized display resolution of the identified first portion area is increased. For example, the localized display resolution is increased up to a native resolution of a display of the device. For a display with a native resolution of 1920 by 1080 pixels, the display resolution can be increased from any value that is lower than the native resolution (e.g., 1080 by 720 pixels) to the native resolution.

Alternatively or additionally, the device can identify a second portion of the displayed electronic content that is different from the first portion. The localized display resolution of the second portion can be decreased from its current resolution. A localized display resolution can be reduced to decrease a processing load of the device while displaying the electronic content and to reduce a power consumed by the device while displaying the electronic content. In an example embodiment, a combination of the first portion and the second portion results in an entire area of the displayed electronic content.

FIG. 6 is a block diagram illustrating eye tracking for display resolution enhancement, according to an example embodiment. FIG. 6 shows a position of an eye's focus during a process of an eye tracking for display resolution enhancement. The position of the eye's focus (or focal point) relative to the displayed electronic content on the display is shown in FIG. 6 in a Cartesian space, similar to as described above with reference to FIG. 3. FIG. 6 shows a displayed electronic content 610 on a device (e.g., device 120).

FIG. 6 shows a plurality of coordinates 620 that represent the user's viewing of the displayed electronic content 610. A local display area for enhancing display resolution is identified by determining that the detected position of the eye for a consecutive series of the captured images has stayed within a distance of a reference position for a period of time. The reference point can be one of a detected position of the eye corresponding to a first image of the consecutive series of the captured images, a detected position of the eye corresponding to a last image of the consecutive series of the captured images, or an average value of a detected position of the eye corresponding to the consecutive series of the captured images.

FIG. 6 depicts region 630 that comprises a set of coordinates that correspond to a consecutive series of the captured images that have stayed within a distance of the reference position for a period of time. As shown in FIG. 6, some of the coordinates that fall outside of the distance from the reference position will fall outside of the region 630. In an example embodiment, region 630 is the first display region whose localized display resolution is enhanced. Region 640 shows region 630 with its localized display resolution enhanced. In an example embodiment, region 640 overlaps region 630 and extends beyond the boundaries of region 630 due to an enhanced localized display resolution. In an exemplary embodiment where a localized display resolution of a second display area that is different from the first display area is reduced, the second display area can be any region of the displayed electronic content 610 that is different from region 630.

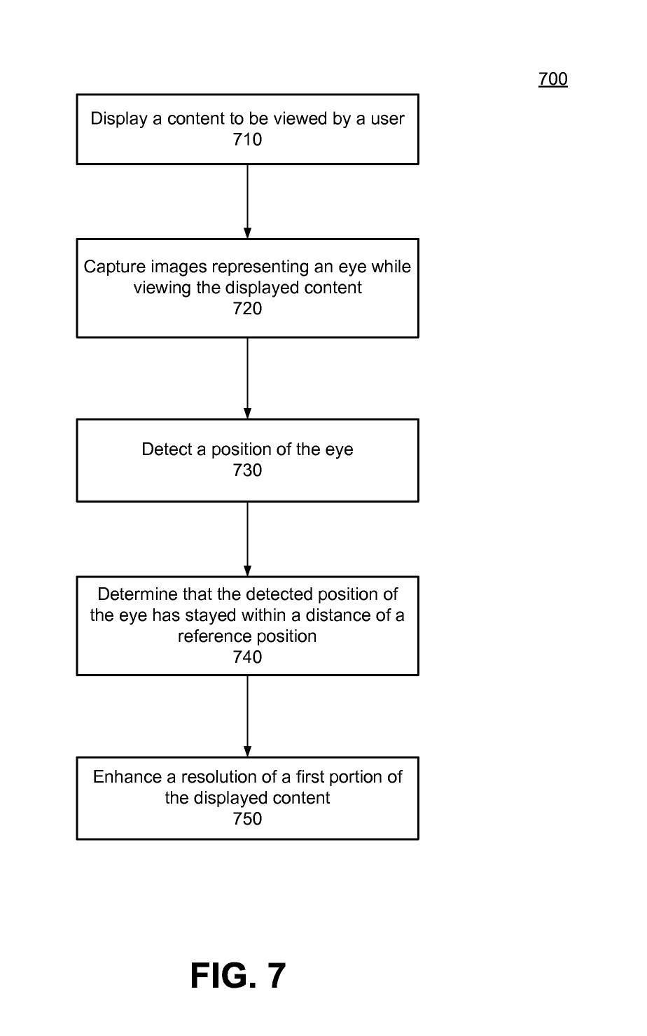

FIG. 7 is a flowchart illustrating a method for display resolution enhancement using eye tracking, according to an example embodiment. An electronic device (e.g., device 120) receives a selection of an electronic content to be displayed on a display of the device. The device then displays 710 the electronic content to be viewed by a user. The displayed electronic content can be content that is internally stored or generated within the device, or can be received external to the device. The displayed electronic content is text-based, image-based, and/or video-based.

The eye motion recognizing subsystem of the device subsequently detects the movement of user's eye(s) when viewing the displayed electronic content. In the presently described embodiment, the device captures 720 a plurality of images, where each image of the plurality of images represents an eye of the user while the user is viewing the displayed electronic content. For example, each image of the plurality of images represents a position of the eye while the eye is viewing a particular area (e.g., a particular portion of an image of an image-based content) of the displayed electronic content. The plurality of images can be captured at a rate that is fast enough to ensure that the device captures all relevant changes in a position of the eye.

The eye motion recognizing subsystem of the device detects 730 a position of the eye based on the captured images such that the device detects a position of the eye for each captured image. For example, the detected position of the eye corresponds to a center of the eye while the eye is viewing a particular area of the displayed electronic content. Alternatively, the detected position corresponds to the area of the displayed electronic content that the eye is viewing and the area is determined by extrapolating the eye position relative to the displayed electronic content. In an example embodiment, the detected position is represented as a Cartesian coordinate comprising a value along the X-axis for a location information of an area that the eye is viewing along a horizontal direction and a value along the Y-axis for a location information of the area along a vertical direction. Exemplary coordinates (e.g., coordinates 320) are described above in detail with reference to FIG. 3.

The processor of the device determines 740 a first display area where the detected position of the eye for a consecutive series of the captured images has stayed within a distance of a reference position for a period of time. The reference point can be, for example, one of a detected position of the eye corresponding to a first image of the consecutive series of the captured images, a detected position of the eye corresponding to a last image of the consecutive series of the captured images, or an average value of a detected position of the eye corresponding to the consecutive series of the captured images. The device can determine a second display area that is different from the first display area, for reducing a localized display resolution of the second display area. In an example embodiment, a combination of the first display area and the second display area can result in an entire area of the displayed electronic content.

The processor of the device enhances 750 a localized resolution of the first portion of the displayed electronic content in response to the device determining the first portion of the displayed electronic content. In an example embodiment, the localized display resolution of the first portion is enhanced up to a native resolution of a display of the device. For example, for a display with a native resolution of 1920 by 1080 pixels, the localized display resolution can be increased from any value that is lower than the native resolution (e.g., 1080 by 720 pixels) to the native resolution. Alternatively, the localized display resolution of the second portion is reduced from its current display resolution to decrease a processing load of the device while displaying the electronic content and to reduce a power consumed by the device while displaying the electronic content.

FIG. 8 is a block diagram of an exemplary device 800 (e.g., device 120) that can implement message read confirmation and display resolution enhancement using eye tracking. Device 800 includes a memory interface 802, one or more data processors, image processors and/or central processing units 804, and a peripherals interface 806. Memory interface 802, one or more processors 804 and/or peripherals interface 806 can be separate components or can be integrated in one or more integrated circuits. The various components in device 800 can be coupled by one or more communication buses or signal lines.

Device 800 can include sensors, devices, and subsystems that can be coupled to the peripherals interface 806 to facilitate multiple functionalities. For example, motion sensor 810, light sensor 812, and proximity sensor 814 are coupled to the peripherals interface 806 to facilitate orientation, lighting, and proximity functions. Other sensors 816, such as a positioning system (e.g., GPS receiver), a temperature sensor, a biometric sensor, or other sensing device, can also be connected to peripherals interface 806 to facilitate related functionalities.

Device 800 also includes eye motion recognizing subsystem 860 to facilitate tracking of eye movement for message read confirmation and/or display enhancement. Eye motion recognizing subsystem 860 includes camera subsystem 862 and optical sensor 864. Example optical sensors include a charged coupled device (“CCD”) or a complementary metal-oxide semiconductor (“CMOS”) optical sensor that facilitate camera functions, such as recording photographs and video clips.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the device is intended to operate. For example, a mobile device can include communication subsystems 824 designed to operate over a GSM™ network, a GPRS network, an EDGE network, a Wi-Fi™ or WiMax™ network, a 3G network, and a Bluetooth™ network. In particular, wireless communication subsystems 824 can include hosting protocols such that the mobile device can be configured as a base station for other wireless devices.

Device 800 further includes audio subsystem 826 that can be coupled to speaker 828 and microphone 830 to facilitate voice-enabled functions, such as voice recognition, voice replication, digital recording, and telephony functions. In some implementations, the device presents recorded audio and/or video files, such as MP3, AAC, and MPEG files.

Device 800 further includes I/O subsystem 840 that can include touch screen controller 842 and/or other input controller(s) 844. Touch-screen controller 842 is coupled to touch screen 846. Touch screen 846 and touch-screen controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 846.

Device 800 further includes input controller(s) 844 that can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration disengages a lock of touch screen 846; and a pressing of the button for a second duration that is longer than the first duration can turn power to the mobile device on or off. The user can be able to customize a functionality of one or more of the buttons. Touch screen 846 can, for example, also be used to implement virtual or soft buttons and/or a keyboard.

Memory interface 802 is coupled to memory 850. Memory 850 can include high-speed random access memory and/or non-volatile memory, such as one or more magnetic disk storage devices, one or more optical storage devices, and/or flash memory (e.g., NAND, NOR). Memory 850 can store an operating system such as Darwin™, RTXC™, LINUX™, UNIX™, OS X™, WINDOWS™, or an embedded operating system such as VxWorks™. The operating system can include instructions for handling basic system services and for performing hardware dependent tasks. In some implementations, the operating system can be a kernel (e.g., UNIX™ kernel).

Memory 850 can also store communication instructions to facilitate communicating with one or more additional devices, one or more computers and/or one or more servers. Memory 850 can include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; and/or other software instructions to facilitate other processes and functions, e.g., access control management functions.

Memory 850 can also store other software instructions (not shown), such as web video instructions to facilitate web video-related processes and functions; and/or web shopping instructions to facilitate web shopping-related processes and functions. In some implementations, the media processing instructions are divided into audio processing instructions and video processing instructions to facilitate audio processing-related processes and functions and video processing-related processes and functions, respectively. An activation record and International Mobile Equipment Identity (“IMEI”) or similar hardware identifier can also be stored in memory 850.

Each of the above identified instructions and applications can correspond to a set of instructions for performing one or more functions described above. These instructions need not be implemented as separate software programs, procedures, or modules. Memory 850 can include additional instructions or fewer instructions. Furthermore, various functions of the mobile device can be implemented in hardware and/or in software, including in one or more signal processing and/or application specific integrated circuits.

The disclosure of the example embodiments is intended to be illustrative, but not limiting. Persons skilled in the relevant art can appreciate that many modifications and variations to the foregoing example embodiments are possible in light of the above disclosure.

1. A computer-implemented method comprising:
displaying, at an electronic device, an electronic message to be viewed by a user, the electronic message comprising a plurality of lines;
tracking, at the electronic device, a position of the user's eye while the user is viewing the electronic message;
generating a plurality of features associated with the user's viewing of the electronic message, the plurality of features including one or more features based on the tracked position of the eye, the one or more features comprise determining a number of lines of the electronic message viewed by the eye, where the number of lines viewed by the eye is less than the plurality of lines of the electronic message; and
determining whether the user has read the displayed electronic message by comparing the number of lines viewed by the eye with a threshold number of lines, the threshold number based on the plurality of lines of the electronic message.

2. The computer-implemented method of claim 1, wherein tracking the position of the eye comprises capturing a plurality of images, each image of the plurality of images representing a position of the eye while the user is viewing the electronic message.

3. The computer-implemented method of claim 2, wherein each image of the plurality of images is converted into each coordinate of a plurality of coordinates, each coordinate representing the position of the eye.

4. The computer-implemented method of claim 3, wherein each image is converted into each coordinate by extracting a change in the position of the eye between the image and an image of the plurality of images immediately prior to the image.

5. The computer-implemented method of claim 3, wherein each coordinate representing a position of the eye is a Cartesian coordinate with X-axis representing a position of the eye in a horizontal direction and Y-axis representing a position of the eye in a vertical direction.

6. The computer-implemented method of claim 5, wherein the plurality of features include determining a number of lines of the electronic message viewed by the eye, the determination is based on comparing the differences of X-coordinates and that of Y-coordinates.

7. The computer-implemented method of claim 6, wherein the determination whether the user has read the electronic message includes determining whether the number of lines viewed by the eye is greater than a percentage of a number of lines of the displayed electronic message.

8. The computer-implemented method of claim 7, wherein the determination whether the user has read the electronic message includes determining a number of times the user has read the electronic message based on the number of lines viewed by the eye and the number of lines of the displayed electronic message.

9. The computer-implemented method of claim 8, wherein the electronic message is categorized based on the number of times the user has read the electronic message.

10. The computer-implemented method of claim 1, wherein one or more features of the plurality of features are generated based on characteristics of the displayed electronic message.

11. The computer-implemented method of claim 2, wherein one or more features of the plurality of features are generated based on the generated plurality of coordinates.

12. The computer-implemented method of claim 1, wherein the determining whether the user has read the electronic message is implemented by a rules engine comprising one or more rules.

13. The computer-implemented method of claim 12, wherein the one or more rules of the rules engine include at least one of: whether a number of lines of the electronic message viewed by the eye is greater than a percentage of a number of lines of the displayed electronic message, whether an amount of time the eye viewed the displayed electronic message is greater than a percentage of an amount of time expected for the displayed electronic message to be read, whether a cumulative change in a position of the eye in a horizontal direction is within a range of an expected change in the horizontal direction, and whether a cumulative change in a position of the eye in a vertical direction is within a range of an expected change in the vertical direction.

14. The computer-implemented method of claim 1, wherein the determining whether the user has read the electronic message is implemented by a machine learning model that receives the plurality of features and outputs a likelihood that the user has read the displayed electronic message.

15. The computer-implemented method of claim 1, wherein the electronic message is either a text-based message or an image-based message.

16. The computer-implemented method of claim 1, wherein the plurality of features include determining an amount of time spent by the eye while viewing the electronic message.

17. The computer-implemented method of claim 2, wherein the plurality of features include determining an amount of time spent by the eye while viewing the electronic message, the determination is based on a number of captured images.

18. The computer-implemented method of claim 16 further comprising:
determining whether the user was surprised while viewing the electronic message, the determination is based on a comparison between the amount of time spent by the eye while viewing the electronic message and an amount of time expected for the displayed electronic message to be read.

19-23. (canceled)
